(19) United States
(12) Patent Application Publication
(10) Pub. No.: US 2014/0360809 A1
(43) Pub. Date: Dec. 11, 2014

(54) REMOVEABLE CRANE BOOM LIFELIME SYSTEM

(71) Applicant: Stephen Garrett ALGUIRE, Lachine (CA)

(72) Inventor: Stephen Garrett ALGUIRE, Lachine (CA)

(21) Appl. No.: 13/913,933

(22) Filed: Jun. 10, 2013

(51) Int. Cl. A62B 35/00

(52) U.S. Cl. CPC A62B 35/0056
USPC 182/36

(57) ABSTRACT

A removable crane boom lifeline system comprising a plurality of support elements, each support element including a base post having a top and a bottom securing members for securing to respective top and bottom side longitudinal lattices of the crane boom, and an extendable post longitudinally and slidingly engaged with the base post, the extendable post being provided near a top extremity with a lifeline anchor for attaching a lifeline thereto.

### CROSS-REFERENCE TO RELATED APPLICATIONS

This application claims the benefits of U.S. provisional patent application No. 61/810,782 filed on Apr. 11, 2013, which is herein incorporated by reference.

### TECHNICAL FIELD

The present disclosure relates to a removable crane boom lifeline system.

### BACKGROUND

Buildings and related structures are commonly constructed with the use of cranes.

Because of its size, the boom of the crane is formed of modular sections, which also allow for the assembly of various size cranes. Assembly and disassembly of the boom require workers to climb unto and move along the modular sections as they are assembled/disassembled. Typically, for safety reasons, workers secure their security harness to the modular sections to prevent falls. However, this requires them to lower themselves to secure their security harness to structural elements of the boom located at their feet, make frequent switches of the structure element they secure themselves to. In the event of a fall, the securing point being at their feet, there is a jolt as the security link picks up the slack between the security harness attachment point and the securing point.

It is to be understood that although reference is made to modular boom sections, the above equally applies to other structures such as, for example, lattice jib sections, hydraulic boom jibs and extensions including any lattice work.

Accordingly, there is a need for a removable crane boom lifeline system that addresses these shortcomings.

### SUMMARY

The present disclosure provides a removable crane boom lifeline system, comprising:
at least one support element, the support element including:
   a base post having a top and a bottom securing members for securing to respective top and bottom side longitudinal lattices of the crane boom: and
   an extendable post longitudinally and slidingly engaged with the base post, the extendable post being provided near a top extremity with a lifeline anchor for attaching a lifeline thereto.

The present disclosure further provides a removable crane boom lifeline system as above, comprising a plurality of support elements, at least two of the plurality of support elements being linked by a plurality of steps therefore forming a ladder.

### BRIEF DESCRIPTION OF THE FIGURES

Embodiments of the disclosure will be described by way of examples only with reference to the accompanying drawings, in which:

FIG. 1 is a perspective view of a crane boom lifeline system mounted to a crane boom section in accordance with an illustrative embodiment of the present disclosure;

FIG. 2 is a perspective view of the mounting of the support posts of the crane boom lifeline system to the lattice of a boom;

FIG. 3 is a side view of a support post of the crane boom lifeline system; and

FIG. 4 is a perspective view of a combination of support posts and ladder in accordance with other illustrative embodiment of the present disclosure.

Similar references used in different Figures denote similar components.

### DETAILED DESCRIPTION

Generally stated, the non-limitative illustrative embodiments of the present disclosure provide a removable crane boom lifeline system that can easily be mounted unto, and removed from, a crane boom (or horizontal jib, lattice jib sections, hydraulic boom jibs, extensions including any lattice work, etc.) that is being assembled or disassembled in order to provide a lifeline that workers can easily access and to which attach their security harness to without having to bend down, the removable crane boom lifeline system being adjustable in height. Furthermore, the removable crane boom lifeline system can also be provided with a ladder attachment which workers can use to climb unto and down from the crane boom that is being assembled or disassembled.

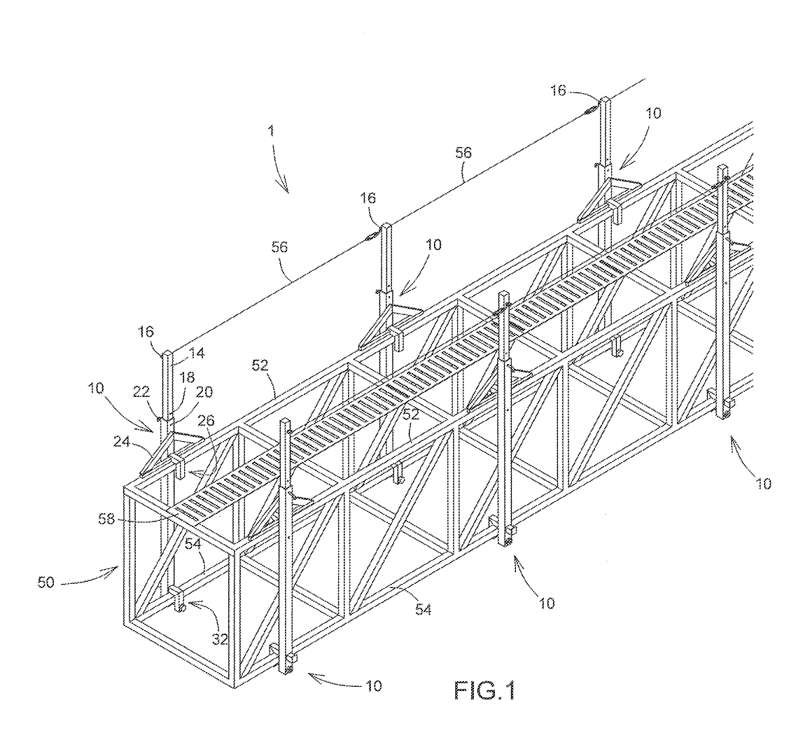

Referring to FIG. 1, there is shown a removable crane boom lifeline system 1 mounted to a crane boom 50 in accordance with an illustrative embodiment of the present disclosure. The crane boom lifeline system 1 consists in a plurality of support elements 10 that can be individually mounted to one or both sides of the crane boom 50 at desired intervals. The support elements 10 are configured to be mounted unto top 52 and bottom 54 side longitudinal lattices of the crane boom 50 in order to provide a lifeline 56 to which workers can secure their security harness to prevent falls while moving on the catwalk 58 during the assembly and disassembly processes of the crane boom 50.

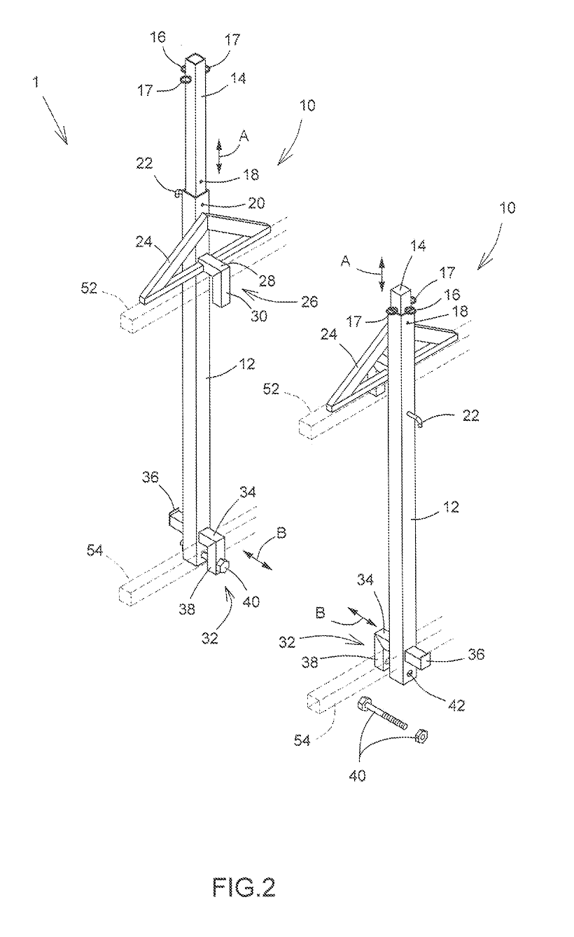

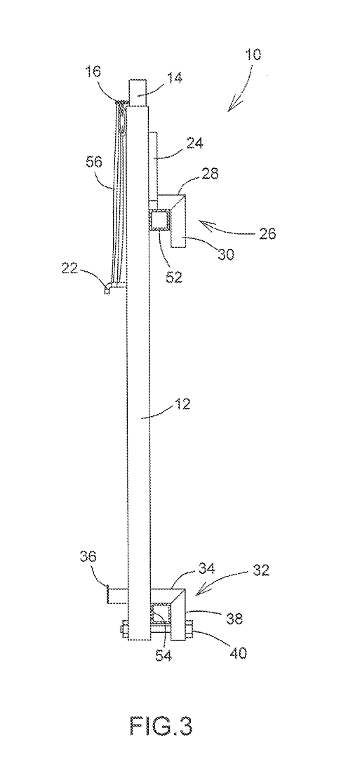

Referring to FIGS. 2 and 3, each support element 10 generally includes a base post 12 and an extendable post 14 longitudinally and slidingly engaged therein, for example square tubing. The extendable post 14 is provided near its top extremity with a lifeline anchor 16 for attaching the lifeline 56 thereto. The portion of the extendable post 14 that extends outwardly from the base post 12 in direction A is adjustable using, for example, a pin 22 configured to be inserted into corresponding holes 18, 20 in the extendable 14 and base 12 posts, respectively. It is to be understood that other height adjustment mechanisms may be used in order to set the length of the extendable post 14 that extends beyond the base post 12. In an alternative embodiment, the extendable post 14 may be longitudinally slidingly engaged to a post section exteriorly mounted to the base post 12, in which case holes 20 would be located on the exteriorly mounted post section.

Each support element 10 is provided with top 26 and bottom 32 securing members positioned on its base post 12 for securing to respective top 52 and bottom 54 side longitudinal lattices of the crane boom 50. In the illustrative embodiment, the securing members 26, 32 form, with segments 28, 30 and 34, 38, respectively, downward “U” receiver structures or hooks configured to receive therein, respectively, the top 52 and bottom 54 side longitudinal lattices. The top 26 and/or bottom 32 securing members may be adjustable in order to adapt to longitudinal lattices 52, 54 of various diameters. The bottom securing member 32 is illustrated in an adjustable form, segment 34 extending from and retracting into the base post 12 in direction B, a stopper 36 insures that the securing member 32 does not separate from the base post 12. It is to be understood, however, that either, both or none of the top 26 and bottom 32 securing members may be adjustable.

A locking mechanism 40 is provided with the bottom securing member 32 in order to ensure that the support element 10 remains in position during use. In the illustrative embodiment the locking mechanism 40 consists in a combination screw and bolt passing through both the base post 12 and segment 38, via hole 42, such that the screw 40 passes just below the bottom side longitudinal lattice 54, thus effectively locking the support element 10 in place. It is to be understood that the locking mechanism may be provided at either or both of the top 26 and bottom 32 securing members. Furthermore, in the case were either or both of the top 26 and bottom 32 securing members are adjustable, the screw and bolt 40 ensures tight fit of the top 52 and/or bottom 54 side longitudinal lattices between the base post 12 and segments 30, 38, respectively.

The support element 10 is also provided with a stabilizing member 24 extending outwardly from opposite sides of the base post 12 at the level of the top 26 securing member so as to be generally parallel to and abut on the top side longitudinal lattice 52 once it is located within the top 26 securing member. The stabilizing member 24 helps ensure that the support element 10 remains stable and generally perpendicular to the top 52 and bottom 54 side longitudinal lattices regardless of forces applied to it.

Referring to FIG. 3, pin 22 can be further configured so as to allow the storage of the lifeline 56 when not in use by wrapping it around the anchor 16 and the pin 22. In an alternative embodiment, a hook may be provided on the base post 12 for wrapping the lifeline 56 around it and the anchor 16.

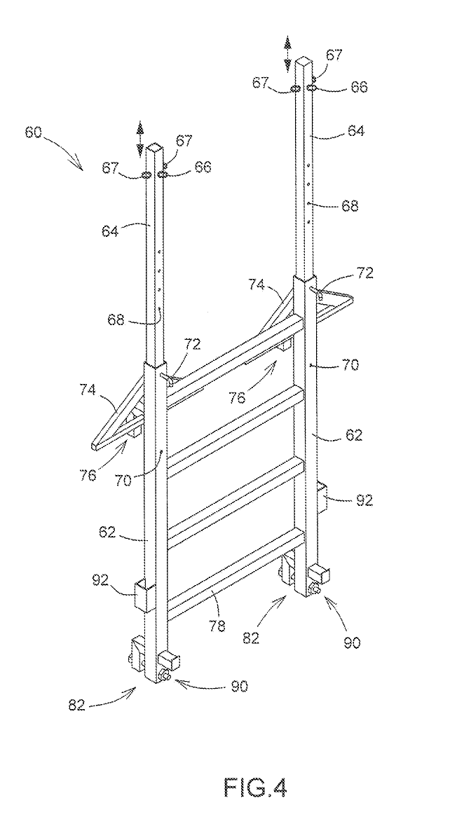

Referring now to FIG. 4, the lifeline system 1 can also be provided with a ladder attachment 60 which workers can use to climb unto and down from the crane boom 50 being assembled or disassembled. In the illustrative embodiment shown, the ladder attachment 60 consists in two ladder base posts 62 linked together by a series of steps 78. The other elements of the ladder attachment 60 have similar features and functions as the support element 10, namely extendable posts 64 longitudinally and slidingly engaged within or to the ladder base posts 62, lifeline anchor 66, pin 72 configured to be inserted into corresponding holes 68, 70 in the extendable 64 and base 62 posts, respectively, top 76 and bottom 82 securing members, locking mechanism 90 and stabilizing member 74,

In an alternative embodiment, the ladder attachment 60 may be composed of two support elements 10 having openings or connectors in one or more sides of their respective base post 12 such that steps 78 may be connected between the two support elements 10, thereby producing the ladder attachment 60.

Optionally, the ladder base posts 62 may be provided with connectors 92, such as tubing brackets, for engaging thereto additional ladder segments.

Optionally still, one or more of the extendable posts 14, 64 may be provided with one or more additional anchors 17, 67 for attaching a support cable for further securing the extendable posts 14, 64 to the crane boom 50 or other structure.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the present disclosure and as hereinafter claimed.

What is claimed is:

1. A removable crane boom lifeline system, comprising:
at least one support element, the support element including:
a base post having a top and a bottom securing members for securing to respective top and bottom side longitudinal lattices of the crane boom; and
an extendable post longitudinally and slidingly engaged with the base post, the extendable post being provided near a top extremity with a lifeline anchor for attaching a lifeline thereto.

2. The removable crane boom lifeline system of claim 1, wherein the extendable post slides in a space within the base post.

3. The removable crane boom lifeline system of claim 1, wherein the extendable post engages a post section exteriorly mounted to the base post.

4. The removable crane boom lifeline system of claim 1, wherein the base post further includes a height adjustment mechanism for adjusting the height of the extendable post.

5. The removable crane boom lifeline system of claim 4, wherein the height adjustment mechanism includes a pin configured to be inserted into corresponding holes in the extendable and base posts.

6. The removable crane boom lifeline system of claim 1, wherein at least one of the top and bottom securing members is provided with a locking mechanism.

7. The removable crane boom lifeline system of claim 1, wherein at least one of the top and bottom securing members is adjustable for adapting to respective top and bottom side longitudinal lattices of various diameters.

8. The removable crane boom lifeline system of claim 7, wherein the at least one adjustable securing member includes a downward “U” receiver structure configured to receive therein a corresponding top or bottom side longitudinal lattice, the receiver structure including a movable segment extending from and retracting into the base post and a stopper insuring that the securing member does not separate from the base post.

9. The removable crane boom lifeline system of claim 8, wherein the at least one adjustable securing member is provided with a locking mechanism.

10. The removable crane boom lifeline system of claim 9, wherein the locking mechanism includes a screw and bolt passing through both the base post and the movable segment such that the screw passes just below the corresponding top or bottom side longitudinal lattice.

11. The removable crane boom lifeline system of claim 1, wherein the base post further includes a stabilizing member extending outwardly from opposite sides of the base post at a level of the top securing member so as to be generally parallel to and abut on the top side longitudinal lattice.

12. The removable crane boom lifeline system of claim 1, wherein the extendable post is further provided near the top extremity with a support anchor for attaching a support cable thereto

13. The removable crane boom lifeline system of claim 1, comprising a plurality of support elements, at least two of the plurality of support elements being linked by a plurality of steps therefore forming a ladder.

14. The removable crane boom lifeline system of claim 13, wherein the at least two of the plurality of support elements linked by a plurality of steps are provided with connectors for engaging thereto additional ladder segments.

15. The removable crane boom lifeline system of claim 1, comprising a plurality of support elements, at least two of the plurality of support elements being provided with openings in one or more sides of their respective base post such that steps may be connected therebetween therefore forming a ladder.

16. The removable crane boom lifeline system of claim 1, comprising a plurality of support elements, at least two of the plurality of support elements being provided with connectors in one or more sides of their respective base post such that steps may be connected therebetween therefore forming a ladder.
